(19) United States
(12) Patent Application Publication
(10) Pub. No.: US 2012/0287748 A1
(43) Pub. Date: Nov. 15, 2012

(54) GYPSUM SLURRY MIXER

(75) Inventors: Fabrice Pourcel, Saint-just-chaleyssin (FR); Fabrice Marandeau, Villefontaine (FR); Olga Volkova, Nice (FR)

(73) Assignee: LAFARGE GYPSUM INTERNATIONAL, St Cloud (FR)

(21) Appl. No.: 13/522,396

(22) PCT Filed: Jan. 17, 2011
(86) PCT No.: PCT/FR2011/050074

§ 371 Date: Jul. 16, 2012

(30) Foreign Application Priority Data
Jan. 20, 2010 (FR) 10/00211

(51) Int. Cl. B01F 7/00; B01F 15/02; B01F 7/16

(52) U.S. Cl. 366/194; 366/279; 366/315

(57) ABSTRACT

A gypsum slurry mixer includes a stationary part delimiting a mixing chamber including an upper part with a supply orifice, a lower part, a lateral part with an outlet orifice defining on the lateral part two end points and the outlet orifice is located within the angular sector formed by the centre of the stationary part and by the 2 points; a smooth movable part having an axis of rotation arranged in the stationary part; and an outlet system including a tubular element oriented tangentially to the stationary part along an axis of which the projection in a plane perpendicular to the axis of rotation is located within the sector formed by the acute angle between the projections, in the perpendicular plane, of the two tangents to the lateral part passing through the end points; and a collecting element.

The present invention relates to an industrial gypsum slurry mixer as well as a method for producing plasterboard.

Plasterboard production plants have initiated an economic and ecological measure to reduce “lost water”. More specifically, drying the plasterboard, which aims to eliminate surplus water, is a step which requires a great deal of energy and the cost thereof is not inconsiderable. In addition, in order to lower the production costs which result from drying the plasterboard and to increase production rates, said reduction of water has become imperative.

Currently, one solution in the economic measure to reduce “lost water”, which has been initiated in plasterboard production plants, is to look at the type of industrial mixer used.

However, the use of gypsum slurries containing less water rapidly becomes difficult, or even impossible, as the fluidity of the gypsum slurry is considerably reduced when the intensity of the mixing increases, using conventional gypsum slurry mixers such as those disclosed, for example, in the application WO 02/092307.

In order to meet industrial requirements it has become necessary to find another means of continuously mixing a gypsum slurry during a method for the industrial production of plasterboard.

In addition, the problem which the invention aims to solve is to provide a new industrial mixer capable of preparing a gypsum slurry having increased fluidity, for example, as a result of controlling the mixing intensity by adapting the configuration and geometry of the constituent elements.

Unexpectedly, the inventors have demonstrated that it is possible to use a mixer comprising a rotor having a minimum number of elements, which are in relief or protrude, for driving and/or mixing the slurry, i.e. a smooth rotor associated with a tangential lateral outlet to prepare a gypsum slurry having increased fluidity.

The object of the present invention is to propose a gypsum slurry mixer, comprising:
a stationary part delimiting a mixing chamber comprising an upper part with at least one supply orifice, a lower part, a lateral part with at least one outlet orifice defining on the lateral part two end points Pm and Pv in a plane parallel to the lower part and the outlet orifice is located within the angular sector formed by the centre of the stationary part and by the 2 points Pm and Pv, the angle α of this sector being less than or equal to 90°;

characterized by
a mobile part having an axis of rotation arranged in the stationary part, the mobile part being smooth; and
at least one outlet means comprising at least:
   one tubular element oriented tangentially to the stationary part along an axis of which the projection in a plane perpendicular to the axis of rotation is located within the sector formed by the acute angle between the projections, in said perpendicular plane, of the two tangents to the lateral part passing through the end points Pm and Pv;
   one collecting element connecting the outlet orifice of the lateral part to the tubular element.

The invention also proposes a method for producing plasterboard, characterized in that the gypsum slurry of the plasterboard is obtained by the mixer disclosed above.

The invention provides at least one of the specific advantages disclosed below.

Advantageously, the mixer according to the invention makes it possible to prepare a gypsum slurry which is generally lighter.

The invention provides as a further advantage that the mixer according to the invention may in certain cases have a rotational speed of its rotor which is reduced relative to conventional known mixers for the same type of application, which represents an energy saving.

A further advantage of the present invention is that the mixer according to the invention makes it possible to reduce the volume of the mixing chamber and thus to minimize the impact of the filling rate of the mixer on the fluidity of the slurry.

The invention provides as a further advantage that the mixer according to the invention makes it possible to reduce the water used in the factories which is required for producing plasterboard.

In addition, the mixer according to the invention has the further advantages of decoupling the rotational speed of the mobile part from the filling rate of the mixer so as to optimize the mixing energy required for the homogenization of the slurry.

Moreover, the mixer according to the invention has a further advantage of limiting the presence of dead zones (dead zones are the zones where the speed of the gypsum slurry is zero or virtually zero) in the mixing chamber and thus reducing the risks of clogging of the mixer.

Furthermore, the simplicity of the geometry of the constituent elements of the mixer makes its production and maintenance simple and cost-effective.

Additionally, the geometry of the mixer and its modularity are such that it may be adapted both to a new production line for plasterboard and to an existing production line.

Finally, the advantage of the invention is to be able to be used in at least one industry, such as the building industry or the industry for the construction of components made of gypsum or in construction markets (in building, civil engineering or a prefabrication plant).

Further features and characteristics of the invention will appear more clearly from reading the following description and figures, given merely by way of illustration and in a manner which is non-limiting.

According to the present invention, the expression “hydraulic binder” is understood to be any component having the property of being hydrated in the presence of water, the hydration thereof making it possible obtain a solid having mechanical characteristics.

The expression “hydraulic binder” also denotes water binders. The hydraulic binder according to the invention may, in particular, be a hydraulic binder based on calcium sulphate. Preferably, the hydraulic binder according to the invention is gypsum.

The expression “hydraulic binders based on calcium sulphate” is understood according to the invention as hydraulic binders based on partially anhydrous or completely anhydrous calcium sulphate.

The following terms and expressions are understood according to the present invention:
gypsum or hydrated calcium sulphate: CaSO₄.2(H₂O);
gypsum or semi-hydrate calcium sulphate or hemi-hydrate calcium sulphate or partially anhydrous calcium sulphate: CaSO₄.0.5H₂O;
anhydrous calcium sulphate or anhydrite (type II or type Ill) or completely anhydrous calcium sulphate: CaSO₄.

The expression “gypsum slurry” is understood according to the present invention as a mixture of water and hydraulic binder based on calcium sulphate (preferably gypsum), foamed or non-foamed, and possibly other components (for example fillers, additives, admixtures, etc.). The expression gypsum slurry also denotes grouts or mortars.

The term “setting” is understood according to the present invention as the passage to the solid state as a result of chemical reaction by hydration of the binding agent. The setting is generally followed by the curing period.

The term “air gap” is understood according to the present invention as the distance between the mobile part and the lower part of the stationary part or the distance between the mobile part and the lateral part of the stationary part.

The plasterboard comprises different types of water. Firstly, the hydration water represents the water necessary for the hydration of anhydrous or partially anhydrous calcium sulphate. Secondly, the plasterboard comprises surplus water which represents the water required to obtain the consistency of the slurry before it sets. Said water is not included in the hydration water.

The invention relates to a gypsum slurry mixer comprising:
a stationary part delimiting a mixing chamber comprising an upper part with at least one supply orifice, a lower part, a lateral part with at least one outlet orifice defining on the lateral part two end points Pm and Pv in a plane parallel to the lower part and the outlet orifice is located within the angular sector formed by the centre of the stationary part and by the 2 points Pm and Pv, the angle α of this sector being less than or equal to 90°;

characterized by
a mobile part having an axis of rotation arranged in the stationary part, the mobile part being smooth; and
at least one outlet means comprising at least:
   one tubular element oriented tangentially to the stationary part along an axis of which the projection in a plane perpendicular to the axis of rotation is located within the sector formed by the acute angle between the projections, in said perpendicular plane, of the two tangents to the lateral part passing through the end points Pm and Pv;
   one collecting element connecting the outlet orifice of the lateral part to the tubular element.

The mixer according to the invention comprises a stationary part, also known as the stator, which delimits or defines an internal volume known as the mixing chamber. The stator is generally of cylindrical shape but other shapes may be appropriate. The stator comprises an upper part, a lower part and a lateral part.

The upper part of the stator comprises at least one supply orifice or a plurality of supply orifices. Said orifices are capable of permitting the introduction into the mixing chamber of liquids, powders, foams or even solids, such as for example water, gypsum, surfactants, inert mineral fillers or mixtures thereof. The supply orifices may be of circular, semi-circular or square shape, or parallelogram shape. The positioning of the water supply orifice may permit the use of the kinetic energy of the water as the mixing agent for all the other constituents. Preferably, the flow of water is able to permit a layer of water to be formed on the surface of the rotor so as to maximise the centrifugal force transmitted to the water by the rotor in order to provide the maximum kinetic energy at that point. This configuration also makes it possible to limit the clogging of the rotor at the point of introduction of the gypsum. The inner or internal face of the upper part of the stator may possibly be scraped using a mechanical means, such as scrapers currently implemented in mixers used nowadays in the plasterboard industry.

The lower part of the stator generally does not comprise any orifices. However, it is perfectly possible to add openings or orifices to the lower part to introduce fluids which permit, for example, the bottom of the rotor to be cleaned or to prevent the slurry from penetrating the air gap, but also to introduce fluid constituents of the slurry (water, admixtures in solution, air or foam) if the optimization of the overall size of the apparatus requires this.

The lateral part of the mixer according to the invention may also comprise openings or orifices to introduce the constituents of the gypsum slurry so as to optimize the overall size of the mixer.

The stator may also have a connecting means between the lateral part and the upper part. Said connecting means may be of curved or rounded shape. Said connecting means preferably makes it possible to guide the slurry when it flows during mixing, rising from the lateral part to the upper part, avoiding the formation of a dead zone. Said connecting means preferably has a radius of curvature of between 0 m and a value equal to the height of the lateral part, more preferably between the values equal to a tenth of the height of the lateral part relative to the distance between the upper part of the rotor and the upper part of the stator.

The mixer according to the invention comprises a mobile, i.e. non-stationary, part, also known as the rotor, arranged in the stator. The mobile part is smooth which means that the mobile part comprises few or no elements which are in relief or protrude and which enable the gypsum slurry to be driven and/or mixed, such as for example teeth, protruding fingers, grooves or channels. The rotor is arranged rotatably, preferably about an axis of rotation. Preferably, the mobile part is a rotor, the direction of rotation thereof enabling the direction of flow of the slurry ejected from the stationary part in the region of the outlet orifice to be identical to the direction of flow of the slurry in the outlet means. Preferably, the mobile part is a smooth disk. Preferably the mobile part is a smooth disk of which the thickness preferably decreases with the distance from the axis of rotation. Even more preferably, the mobile part is a smooth disk of uniform thickness. Preferably, the distance between the mobile part and the lower part or the lateral part (air gap) ranges between 0.1 to 5 mm. The diameter of the rotor is determined relative to the dimensions of the stator, taking into account the air gap.

The lateral part comprises at least one outlet orifice. Said outlet orifice(s) is(are) capable of permitting the outlet of a more or less fluid liquid from the mixing chamber, such as for example liquid gypsum slurry before it sets. The shape thereof may be of any type. Preferably, the outlet orifice is a hole of rectangular shape, located in the lateral part of the stator. The outlet orifice is located in the angular sector formed by the centre of the stationary part and by the 2 points Pm and Pv, the angle a of this sector being less than or equal to 90°, preferably less than or equal to 70°, more preferably less than or equal to 50°. The angle a of this sector is never able to be zero. The apex of said angular sector is the centre of the stationary part.

The mixer comprises at least one outlet means, comprising at least one tubular element and at least one collecting element.

The tubular element is oriented tangentially to the stationary part along an axis of which the projection in a plane perpendicular to the axis of rotation of the mobile part is located within the sector formed by the acute angle between the projections in said perpendicular plane of the two tangents passing through the end points Pm and Pv. Said tubular element preferably makes it possible to orientate or guide the flow of slurry in a direction parallel to the plane formed by the lower face of the rotor, the walls of the tubular element being able to be rigid or flexible.

The collecting element may be hollow. The internal section of the collecting element in said perpendicular plane is preferably entirely or partially located between the two tangents passing through the end points Pm and Pv. The collecting element provides the connection between the lateral part of the stator and the tubular element of the outlet means. The collecting element may, for example, be a tubular part, a tube of square section, a sleeve or a cone fixed to the outlet orifice of the lateral part of the stator. According to a variant of the invention, the collecting element may comprise means for injecting fluids, such as for example a pressurized water injector.

According to a variant, the mixer comprises at least one outlet means able to comprise at least one pressure regulating element. Said element makes it possible, in particular, to adjust the loss of pressure in the mixer so as to control the filling rate thereof. A pinch valve may be cited, for example, as a pressure regulating element.

According to a variant, the mixer comprises at least one outlet means able to comprise at least one transport element: said element makes it possible to convey the slurry from the outlet of said element to the area of use, its length being the shortest possible length and its maximum curvature being less than 45°.

According to a preferred variant of the invention, the mixer comprises at least one outlet means comprising four elements: a tubular element, a collecting element, a pressure regulating element and a transport element. The outlet means advantageously makes it possible to collect, direct, regulate the pressure of and transport the gypsum slurry from the outlet orifice to the place of use of the slurry, for example a production line for plasterboard. The outlet means may have tubular transport elements of which the section, whether symmetrical or not and of any shape, is preferably circular, and of which the outlet diameter of the transport element guarantees an ejection speed of the slurry which is compatible with the distribution of the slurry, preferably without splashing onto the production line for plasterboard. According to a specific embodiment, the same outlet means may have variable shapes. By way of example may be cited an outlet means having a collecting element providing the connection between an outlet orifice of rectangular shape and a tubular element having a cylindrical shape, which is in turn connected to the transport element of tubular curved shaped by means of a pinch valve, making it possible to regulate the pressure. The shape of the transport element of the outlet means is such that changes in direction imposed on the flow of the gypsum slurry do not significantly increase the loss of pressure of the slurry, whether this is by one-off or regular losses of pressure. Typically, the curves, such as for example a bend in a tubular part, must not have an angle of greater than 45° so that significant one-off losses of pressure are not caused. The total length of the outlet means is preferably the shortest possible length to avoid the occurrence of significant regular losses of pressure of the slurry when flowing in the outlet means. The total length of the outlet means is preferably less than twice the diameter of the rotor, more preferably less than the diameter of the rotor. Similarly, the narrowest section of the outlet means is preferably the widest possible section. For example, the maximum surface of the section of the outlet means is equal to the surface of the section of the outlet orifice formed in the lateral wall of the stator.

The mixer according to the invention may be positioned on the production line for plasterboard, taking for reference the axis of rotation of the rotor, and the position and the axis of the outlet orifice of the lateral part. The axis of rotation of the rotor is inscribed within a vertical plane perpendicular to the direction of the production line for plasterboard. In this plane, the axis of rotation of the rotor may form an angle δ with the vertical. Said angle may vary from 0° to 90°, more preferably from 0° to 45°. The position of the outlet orifice of the lateral part may adopt a position varying from one end to the other of the cardboard which serves as the facing for the plasterboard, more preferably in the centre of the cardboard. The orientation of the outlet means may be in all possible directions, to the extent that the direction of flow of the slurry follows a trajectory from the top (the mixer) to the bottom (the production line for plasterboard). In the case of an existing production line for plasterboard, the choice of its orientation is guided by the overall size of the mixer and the space available on the production line for plasterboard.

So as to guarantee the adaptability of the mixer to different flow rates of the slurry required for the production of plasterboard of different sizes, the rotational speed of the rotor and the dimension of the outlet orifice may be modified, in a static manner (requiring the stoppage of the installation to alter the adjustments) or in a dynamic manner (alterations to the adjustments during the operation of the mixer).

The operation of such a mixer makes it possible to blend or mix gypsum to obtain a gypsum slurry. The primary materials are preferably introduced into the mixer via its upper part. According to a variant, the gypsum is introduced separately via a supply orifice in the vicinity of the lateral wall, the mixing water is introduced via one or more further supply orifices in the vicinity of the axis of rotation of the rotor. By the rotational effect of the rotor in the stator, the water comes into contact with the gypsum and forms a sludge or slurry in the mixing chamber. Still by the effect of rotation of the rotor in the stator, the gypsum slurry is projected toward the lateral wall of the stator and discharged via the outlet orifice present in the region of said lateral wall. According to a further variant, foam is introduced into the mixing chamber, in addition to the gypsum and water in order to obtain a foamed gypsum slurry.

Advantageously, the mixer according to the invention may be incorporated in a continuous production line for plasterboard.

The invention also relates to a production method for plasterboard, characterized in that the gypsum slurry of the plasterboard is obtained by the mixer according to the invention and disclosed above.

Preferably, the method according to the invention comprises the following steps:

(i) introducing into the stationary part of the mixer according to the invention at least water and gypsum and possibly 0 to 25% additives, percentage by weight;

(ii) driving the water and the gypsum by rotating the mobile part of the mixer according to the invention; and

(iii) ejecting by centrifugal forces the mixture obtained in step (ii) in a direction tangential to the mobile part and located within the angular sector incorporating the outlet means.

The angular sector of step (iii) is the sector formed by the acute angle between the projections in a plane perpendicular to the axis of rotation of the mobile part of the two tangents passing via the end points Pm and Pv.

Preferably, the method according to the invention is a continuous method where the steps (i), (ii) and (iii) take place simultaneously.

Preferably and according to a variant, the method according to the invention uses the mixer according to the invention positioned so that the axis of rotation of the rotor is inscribed in a vertical plane perpendicular to the direction of the production line for plasterboard, and in this plane, the axis of rotation of the rotor may form an angle δ with the vertical, said angle varying from 0° to 90°, more preferably from 0 to 45°.

### BRIEF DESCRIPTION OF THE FIGURES

The following figures illustrate the invention, without limiting the scope thereof.

FIG. 1 is a partial perspective schematic view of an embodiment of the mixer according to the invention.

FIG. 2 is a partial schematic view in profile of an embodiment of the mixer according to the invention.

FIG. 3 is a partial perspective schematic view of an embodiment of the mixer according to the invention with an outlet comprising a pressure regulating element and a transport element.

FIG. 4 is a partial schematic view from above of an embodiment of the mixer according to the invention.

FIG. 5 is a partial perspective schematic view of an embodiment of the rotor according to the invention.

FIG. 6 is a partial schematic view in profile of an embodiment of the mixer according to the invention in a production line for plasterboard.

### DESCRIPTION OF EMBODIMENTS OF THE INVENTION

The following embodiments illustrate the invention without limiting the scope thereof.

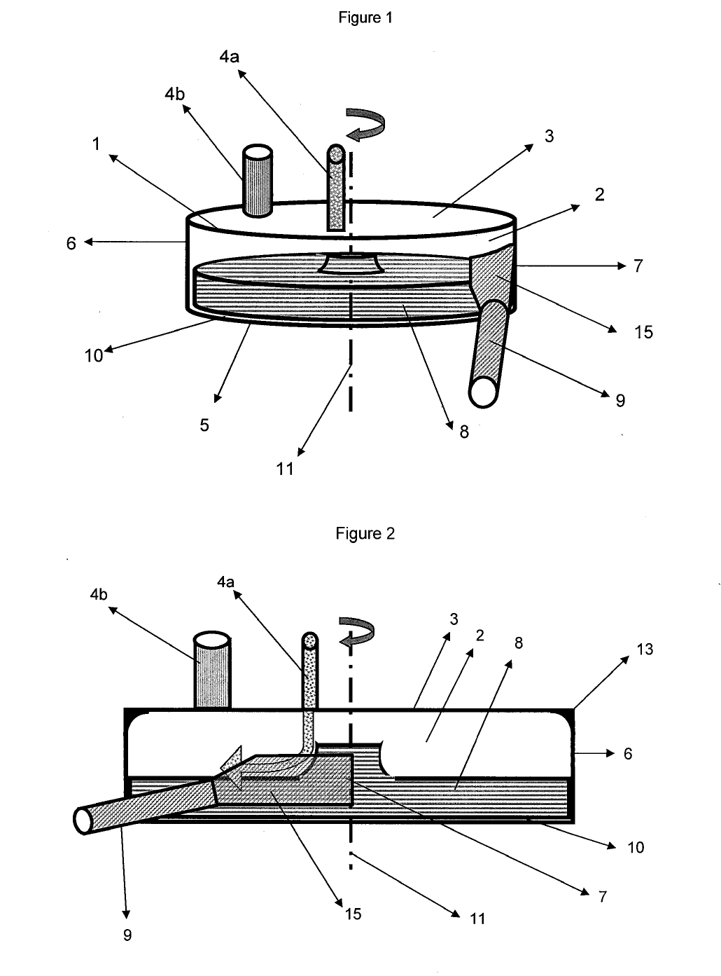

With reference in the first instance to FIGS. 1 and 2, the mixer according to the invention comprises a stationary part, the stator (1), which is of cylindrical shape and which is wider than it is higher. Said stator (1) delimits a mixing chamber (2) in which the constituents permitting a gypsum slurry to be obtained are mixed. The upper part (3) of the stator (1) comprises an orifice for supplying water (4a) and an orifice for supplying semi-hydrate calcium sulphate (4b). The section of the orifices (4a) and (4b) is of circular shape. The stator (1) comprises a lower part (5) which in this embodiment does not comprise orifices. The stator (1) comprises a lateral part (6) having an outlet orifice (7). The mixer comprises a non-stationary part (8), the rotor (8), arranged in the stator (1), said part being smooth. The mixer comprises a tubular element (9) which is in the form of a sleeve made of flexible material of variable length. Said tubular element (9) is tangential to the lateral part (6). The mixer comprises a collecting means (15). The air gap (10) has a volume which is reduced to the greatest possible extent. To this end, the rotor (8) is positioned in the lower part of the mixing chamber (2). Preferably, the water and semi-hydrate calcium sulphate continuously arrive simultaneously into the mixing chamber (2). The speed of arrival of the water transmits to said water a kinetic force which is transformed into a centrifugal force when it comes into contact with the rotor (8) and thus permits a layer of water to be created on the rotor (8). The orifice (4a) is located in the vicinity of the axis of rotation (11) of the rotor. In contrast, the orifice (4b) is located at the point which is the furthest away from the axis (11) of the rotor. The gypsum slurry formed in the mixing chamber (2) is driven by the rotor (8) toward the outlet orifice (7) and transported to the production line for plasterboard via the sleeve (9).

With reference to FIG. 2, the mixer also has a connecting means (13) between the lateral part and the upper part. Said connecting means (13) is of rounded shape in its part in contact with the mixing chamber (2). Said connecting means preferably makes it possible to channel the slurry when it flows during mixing, rising from the lateral part to the upper part, avoiding the formation of a dead zone. Said connecting means preferably has a radius of curvature of between 0 m and a value equal to the height of the lateral part, more preferably between the values equal to a tenth of the height of the lateral part and the distance between the upper part of the rotor and the upper part of the stator.

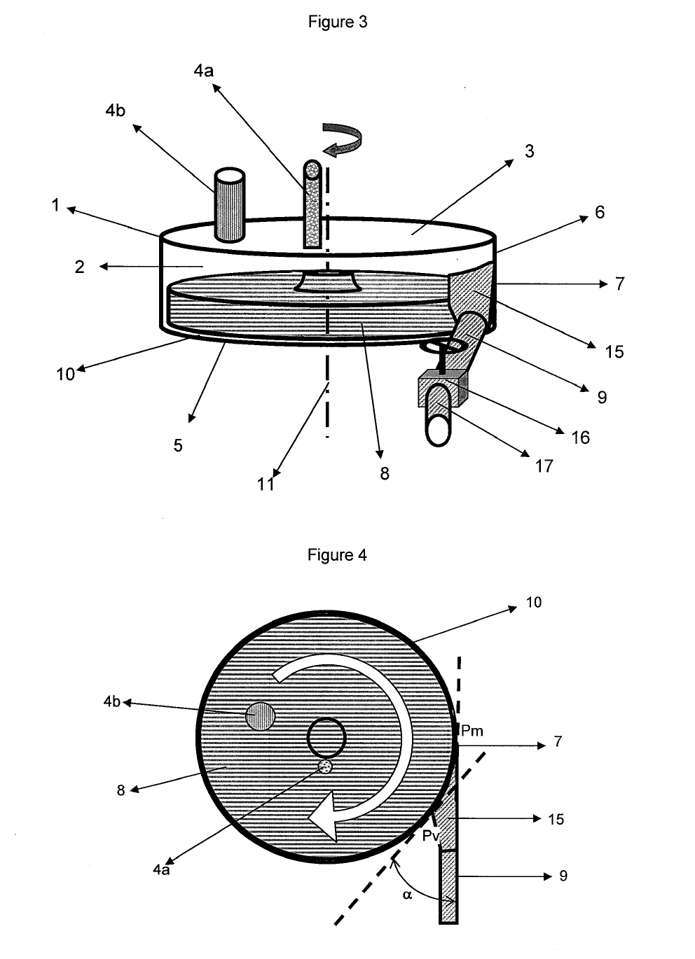

With reference to FIG. 3, the mixer has an outlet means comprising the tubular element (9), the collecting element (15) connecting the outlet orifice (7) of the lateral part (6) to the tubular element (9), a pressure regulating element (16) and a transport element (17).

With reference to FIG. 4, the tubular element (9) is oriented along an axis of which the projection in a plane perpendicular to the axis of rotation of the rotor (8) is located between the projections in said perpendicular plane of the two tangents passing through the end points Pm and Pv.

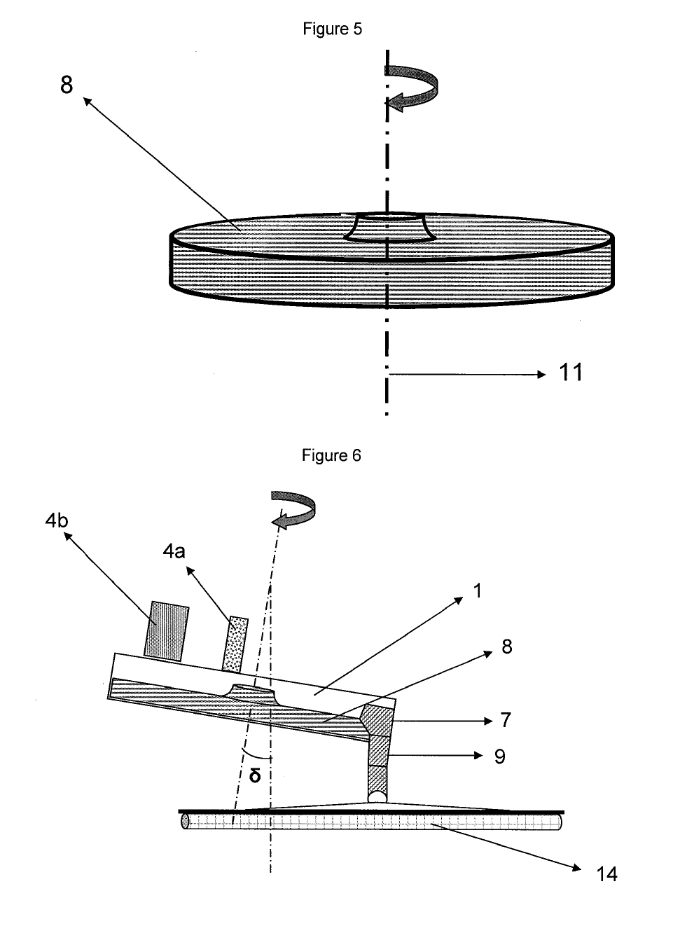

With reference to FIG. 5, the rotor (8) is a smooth disk made of metal, pivoting about the axis of rotation (11) of the rotor.

With reference to FIG. 6, the mixer according to the invention is positioned above the production line for plasterboard (14). The sheets of plasterboard (14) appear in profile. The angle δ is 6. The position of the outlet orifice (7) is equidistant from the edges of the production line for plasterboard. The position of the tubular element (9) is in the direction of travel of the production line for plasterboard, the outlet thereof being closest to the conveyor belt to limit splashing.

1. A gypsum slurry mixer comprising:
a stationary part delimiting a mixing chamber comprising an upper part with at least one supply orifice, a lower part, a lateral part with at least one outlet orifice defining on the lateral part two end points in a plane parallel to the lower part and the outlet orifice is located within tan angular sector formed by a centre of the stationary part and by the two points, an angle α of the sector being less than or equal to 90°;
a movable part having an axis of rotation arranged in the stationary part, the movable part being smooth; and
an outlet system comprising:
a tubular element oriented tangentially to the stationary part along an axis of which the projection in a plane perpendicular to the axis of rotation is located within the sector formed by an acute angle between the projections, in said perpendicular plane, of the two tangents to the lateral part passing through the two end points; and
a collecting element connecting the outlet orifice of the lateral part to the tubular element.

2. The mixer according to claim 1, wherein the lower part does not comprise orifices.

3. The mixer according to claim 1, wherein the movable part comprises few or no elements which are in relief or protrude and which enable the gypsum slurry to be driven and/or mixed.

4. The mixer according to claim 1, wherein the movable part is a smooth disk.

5. The mixer according to claim 1, wherein the movable part is a rotor, a rotational direction thereof enabling the direction of flow of the slurry ejected from the stationary part in the region of the outlet orifice to be identical to a direction of flow of the slurry into the outlet system.

6. The mixer according to claim 1, wherein a distance between the movable part and the lower part or the lateral part ranges between 0.1 to 5 mm.

7. The mixer according to claim 1, wherein the outlet system comprises at least one pressure regulating element.

8. A method for producing a plasterboard, wherein the gypsum slurry of the plasterboard is obtained by the mixer according to claim 1.

9. The method according to claim 8, wherein the mixer is positioned so that the axis of rotation of the rotor is inscribed in a vertical plane perpendicular to the direction of the production line for plasterboard, and, in said plane, the axis of rotation of the rotor forming an angle δ with the vertical, said angle varying from 0° to 90°.

10. The method according to claim 8, comprising:
(i) introducing into the stationary part of the mixer, at least water and gypsum and optionally 0 to 25% additives, percentage by weight;
(ii) driving the water and the gypsum by rotation of the movable part of the mixer; and
(iii) ejecting by centrifugal forces the mixture obtained in (ii) in a direction tangential to the movable part and located within the angular sector including the outlet system.

11. The method according to claim 10, wherein (i), (ii) and (iii) take place simultaneously.

12. The mixer according to claim 3, wherein the elements are teeth, protruding fingers, grooves or channels.

13. The method according to claim 9, wherein said angle varies from 0° to 45°.
